(19) United States
(12) Patent Application Publication
(10) Pub. No.: US 2005/0200339 A1
(43) Pub. Date: Sep. 15, 2005

(54) Methods for electrically isolating a portable electrically-operated device and converter module for portable electrically-operated device

(76) Inventors: Steven J. Phillips, Ellicott City, MD (US); Daniele C. Brotto, Baltimore, MD (US); David A. Carrier, Aberdeen, MD (US); Jeffrey J. Francis, Nottingham, MD (US); Andrew E. Seman JR., White Marsh, MD (US); Danh Thanh Trinh, Parkville, MD (US); Christopher R. Yahnker, Raleigh, NC (US)

Correspondence Address: HARNESS, DICKEY & PIERCE, P.L.C., P.O. BOX 8910, RESTON, VA, 20195, US

(21) Appl. No.: 11/071,210

(22) Filed: Mar. 4, 2005

Related U.S. Application Data
(60) Provisional application No. 60/551,357, filed on Mar. 10, 2004.

(51) Int. Cl. G05F 1/40

(52) U.S. Cl. 323/243

(57) ABSTRACT

A method for electrically isolating a portable, electrically-operated device, in which a converter module for converting electrical power from an external power source to a desired DC voltage for the device may be adapted to be removeably attached to the device. The converter module may include a switch mode transformer for electrically isolating the external power source from the device.

### CROSS-REFERENCE TO RELATED APPLICATIONS

This application claims the benefit under 35 U.S.C. § 119(e) to U.S. provisional application Ser. No. 60/551,357, filed Mar. 10, 2004. The entire contents of the disclosure for this provisional application is incorporated herein by reference.

### BACKGROUND OF THE INVENTION

1. Field of the Invention

The present invention relates generally to methods for electrically isolating an electrically-operated device such as a power tool from an external power source providing an AC source voltage that is converted to a desired DC voltage for powering the device within a corded converter module operatively attached to the device, and to a portable, electrically-operated device which can alternatively operate in either a cordless mode from a self-contained power source or a corded mode from a AC/DC generator power source.

2. Description of the Related Art

Portable electrically-operated devices that function in a cordless mode typically include a housing which has a chamber for receiving and retaining a removable battery pack. The battery pack completely encloses one or more cells and provides the necessary DC power for operation of the device. Historically, these portable electronic devices have included low power devices such as personal computers and cellular phones.

A battery pack of a portable electronic device typically has a plurality of battery cells connected in series. The maximum number of battery cells connected in series in one battery pack is determined by the relationship between the output voltage of the battery unit and a power source voltage supplied from outside at the time of charging. For instance, the typical output voltage of one nicel-cadmium (NiCd) battery cell or one nickel-metal-hydride (NiMH) battery cell is 1.2 V, and the power source voltage supplied at the time of charging is approximately 1.7 V. Assuming that an 18 volt output voltage from a battery pack is suitable for most general purpose electronic devices, the maximum number of NiCd or NiMH battery cells connected in series in the battery pack is about 15. On the other hand, the typical output voltage of one Lithium-ion (Li+) battery cell is approximately 3.6 V. Accordingly, the maximum number of Li+ battery cells connected in series in one battery pack is about 5 cells.

Recently, improvements in battery technology have led to the development of batteries that may store more energy and may be capable of driving higher power devices than personal computers or cell phones. These devices may include, for example, portable power tools and appliances operating at power levels from 50 watts up to several thousand watts. Cordless power tools permit work operations to be performed in areas where a conventional AC power source is not available or inconvenient to use. However, the effective charge capacity of the battery pack, and the availability of replacement battery packs, may limit the use of cordless devices. When the battery pack is discharged, it must be recharged or replaced with a fully charged pack.

Both batteries and battery chargers are relatively expensive in comparison to the electrically-operated power device for which they are intended. NiCd and NiMH batteries for high power applications requiring at least about 10.8 volts may represent approximately 30% of the total cost of the applicable electrically-operated power device. A battery pack having a Li+ cell chemistry may represent an even higher percentage of the total cost of the applicable power device. Additional batteries are required to permit cordless mode operation while a battery is recharged and to replace dead batteries. High power levels drawn from batteries during operation of the power tool, the depth of discharge of the battery, the number of charge/discharge cycles, and the speed with which a battery is recharged all contribute to shortening the usable lifetime of a battery. Fast chargers can cost more than the power tool or appliance that is powered by the battery.

There are two basic types of battery chargers, trickle chargers and fast chargers. Trickle chargers are significantly less expensive than fast chargers, however a trickle charger requires approximately 1/2 day for recharging a battery pack. A fast charger on the other hand can recharge a battery pack within about an hour. Therefore, there is some trade off to be evaluated between using a trickle charger with a large number of battery packs versus using a costly fast charger with very few replacement battery packs.

To limit power device down time in the field while a battery pack is being charged, electrically-operated power devices such as portable cordless power tools may be configured to receive an optional corded AC/DC converter module that is connected to an AC power source and designed to replace the battery pack. The corded converter module converts power from the AC source to a regulated lower voltage DC level that is usable by the motor of the power tool or device. The corded converter module may allow a tool operator to use the tool in either a cordless battery mode or the corded AC mode, as needed. The availability of an AC/DC converter enables the operator of a cordless tool to complete a project when the battery pack has been discharged, or to continue to use the tool while the battery pack is charging and a fully charged backup battery pack is unavailable. Hence, the need for extra battery packs may be reduced by using a corded converter module.

However, the prior art corded AC/DC converter module may be constrained by a number of factors such as the physical envelope (i.e., shape which conforms to pack it is replacing), the required output power level, the voltage conversion ratio of the converter, safety requirements to protect the operator from electrical shock, and cost. The envelope of the corded converter module must conform to the envelope of the battery pack with which it is interchangeable. With the increased volumetric requirements for battery packs, there may be increased volume available for housing a corded converter.

The power output level of an AC/DC converter module is directly related to the available volume within the container envelope. The power output levels adequate to drive power devices such as power tools are possible within the physical envelope of commercial battery packs.

The voltage conversion ratio of the AC/DC converter is the ratio between the rectified input voltage and the converter output voltage. The converter output voltage is set to a level roughly equivalent to the battery voltage. The greater the voltage conversion ratio, the more difficult it is to accurately regulate the output voltage.

The safety regulations are typically met by isolating the operator of the power device from the AC power source. Commercially available systems meet the safety regulations by employing a power transformer to isolate the output power of the converter module from the relatively high voltage AC input power source. Conventional power transformers are typically low frequency (60 Hz) expensive and bulky in comparison with the other electronic devices of the converter module.

Attempts to reduce costs of corded AC/DC converter modules have concentrated on optimizing the output power capability of the converter module for a given power device. By designing the AC/DC converter module for the minimum output power required to satisfactorily drive the power device, lower cost electronic components can be chosen for the converter.

Commonly assigned U.S. Pat. No. 6,675,912 to Carrier (the '912 patent), entitled “Dual-Mode Non-isolated Corded System for Transportable Cordless Power Tools” has proposed a corded AC/DC voltage converter that is provided with a non-isolated power supply to generate power and current required by a driven power device, such as a cordless power tool. In the '912 patent, electrical isolation is provided by a double insulation layer of insulation materials in the power tool itself.

For example, FIG. 1 is a cross-sectional view of an armature of DC power tool motor that employs double insulation, as described in the '912 patent. Double insulation techniques are well known in the art. Double insulated tools are typically constructed of two separate layers of electrical insulation or one double thickness insulation layer between the operator and the tool's electrical system.

Referring to FIG. 1, a method of employing double insulation of a motor armature 220 of a power tool in the '912 patent is illustrated. The armature 220 may consist of a shaft 222 with a core built up over it. The core may be composed of a plurality of laminations 226 with notches along an outer periphery (not shown) to hold armature windings 224. A chuck 228 is built onto the shaft 222 at one end of the armature laminations 226 to provide a means of affixing a device (such as a drill bit) to a working end of the power tool. A molded plastic insulator 230 provides basic insulation between the armature windings 224 and the laminations 226, as well as between the shaft 222 and the armature windings 224. A press fit plastic tube insulator 232 encases the shaft 222. The plastic tube insulator 232 provides supplementary insulation to prevent the shaft from becoming energized if the basic insulation breaks down.

Use of double-insulation in the tool may provide a lower cost AC/DC converter than prior art AC/DC converters employing bulky, more expensive isolation transformers. However, as even greater power levels may be desired for portable electronic devices such as cordless power tools, obtaining even further cost reductions, without reducing the output power level of a corded AC/DC converter module, may be desired.

### SUMMARY OF THE INVENTION

An exemplary embodiment of the present invention is directed to a method of electrically isolating an electrically-operated device from an external power source providing an AC source voltage that is converted to a desired DC voltage for powering the device within a corded converter module operatively attached to the device. The converter module may include a switch-mode transformer therein. In the method, switch mode control in the converter module may be employed to control a secondary side of the switch-mode transformer, so as to electrically isolate the device from the external power source in the converter module.

Another exemplary embodiment of the present invention is directed to a method of powering an electrically-operated device adapted to be powered from both a removable cordless power supply and a removable corded power supply. The corded power supply may include a converter module for converting a source voltage from the corded power supply to a desired DC voltage for powering the device. In the method, the cordless power supply may be removed from the device and the converter module attached to the device. The converter module may include a cord connected to an unregulated source voltage for providing the source voltage to the converter module and may include an isolation transformer therein. An unregulated source voltage may be converted to an intermediate DC voltage in the converter module. A duty cycle at which a pair of transistors in the module cycle may be controlled to control a primary side of the isolation transformer, so as to provide electrical isolation between the primary and secondary sides of the isolation transformer to electrically isolate the corded power supply from the device. The intermediate DC voltage may be stepped down to the desired DC voltage in the isolation transformer of the module, in order to power the device with the desired DC voltage.

Another exemplary embodiment of the present invention is directed to a method of supplying power to a power tool operable in a given voltage range, in which the power tool may have one or more exposed surfaces. The method may include connecting a corded, isolated power supply module to the power tool and to a AC source of relatively high voltage electric power. The corded, isolated power supply module may provide electrical isolation for the power tool by controlling a duty cycle at which a pair of transistors in the module cycle, in an effort to prevent the exposed surfaces of the power tool from becoming electrically energized. The method may include converting power from the AC source to a DC voltage within the given voltage range that is isolated from the AC source, and powering the power tool with the DC voltage.

Another exemplary embodiment of the present invention is directed to a corded/cordless system for a power tool. The system may include a power tool operable at a given DC voltage. The power tool may include a motor, an exterior, an interior and a power tool interface for mechanically and electrically mating with a power supply module. The system may include a corded, isolated power supply module having a cord connected to an external source of electric power. The module may be releasably attached to the DC power tool and may include a circuit adapted to convert an AC source voltage from the external source to a desired DC voltage for powering the power tool. The circuit may include an isolation transformer therein to electrically isolate the external source from the power tool by controlling a duty cycle at which a pair of transistors in the isolation transformer cycle, so as to electrically isolate a primary side from a secondary side of the isolation transformer.

Another exemplary embodiment of the present invention is directed to a converter module for converting electrical power from an external power source to a desired DC voltage for a portable, electrically-operated device and adapted to be releasably attached to the device. The converter module may include converting means for converting a given unregulated source voltage to an intermediate DC voltage, and an isolation transformer for stepping down the intermediate DC voltage to a desired DC voltage while serving to electrically isolate the device from the external power source. The converter module may include control circuitry for controlling a duty cycle at which a pair of transistors of the isolation transformer cycle to control a primary side of the isolation transformer.

Another exemplary embodiment of the present invention is directed to a non-isolated power tool adapted to receive one of a releasably attachable cordless battery supply module and a releasably attachable corded converter module. Electrical isolation for the power tool may reside in the attached battery supply module or converter module.

### BRIEF DESCRIPTION OF THE DRAWINGS

The exemplary embodiments of the present invention will become more fully understood from the detailed description given herein below and the accompanying drawings, wherein like elements are represented by like reference numerals, which are given by way of illustration only and thus are not limitative of the exemplary embodiments of the present invention.

FIG. 1 is a cross-sectional view of an armature of DC power tool motor that employs a method of double insulation.

FIG. 2 is a three-dimensional view partially showing the manner of connecting a battery pack to an electrically-operated device in accordance with an exemplary embodiment of the present invention.

FIG. 3 is a three-dimensional view partially showing the manner of connecting an AC/DC power converter module to the device of FIG. 2.

FIG. 4A is a three-dimensional exploded view of an exemplary battery pack.

FIG. 4B is a three-dimensional exploded view of the AC/DC power converter in accordance with an exemplary embodiment of the present invention.

FIG. 5 is a two-dimensional view of an interface between the AC/DC power converter module and an exemplary terminal block of an electrically-operated device, in accordance with an exemplary embodiment of the present invention.

FIG. 6 is a two-dimensional view of an interface between the AC/DC power converter module and an exemplary terminal block of an electrically-operated device, in accordance with an exemplary embodiment of the present invention.

FIG. 7 is a flow diagram illustrating a method of isolating an electrically-operated device from a power source in the AC/DC power converter module of FIG. 3, in accordance with an exemplary embodiment of the present invention.

FIG. 8 is a block diagram of a power converter assembled and contained within the AC/DC power converter module of FIG. 3.

FIG. 9 is a schematic diagram of the power stage of the power converter of FIG. 8.

FIG. 10 is a schematic diagram of the control circuit of the power converter of FIG. 8.

FIG. 11 is a signal diagram showing the voltage and current waveforms associated with the AC/DC power converter in accordance with an exemplary embodiment of the present invention.

FIG. 12 is a cross-sectional view of an armature of a non-insulated DC power tool motor usable with an isolated AC/DC power converter module in accordance with an exemplary embodiment of the present invention.

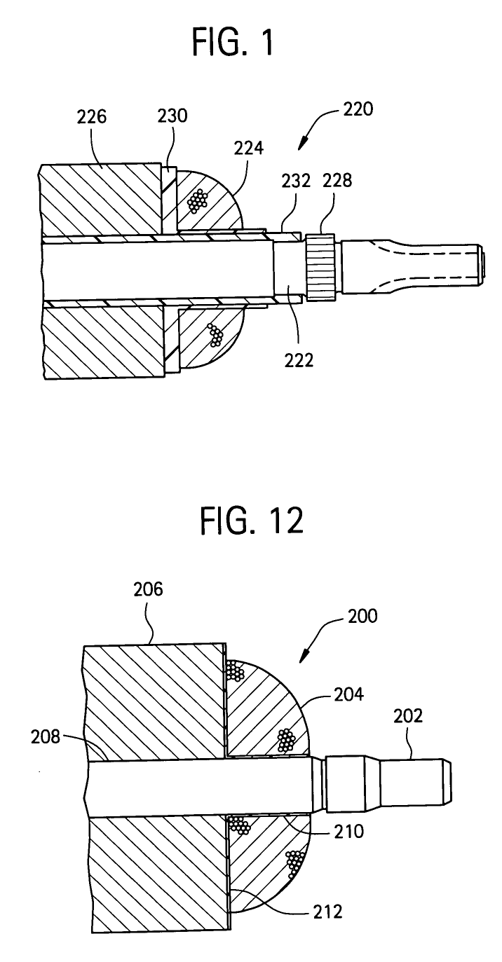

### DETAILED DESCRIPTION OF THE EXEMPLARY EMBODIMENTS

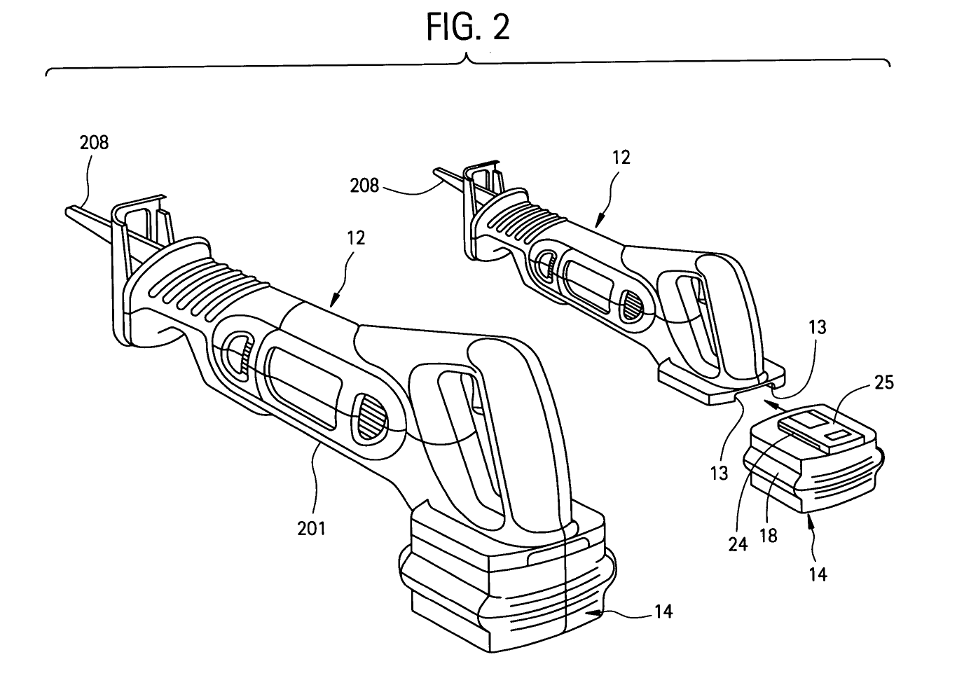

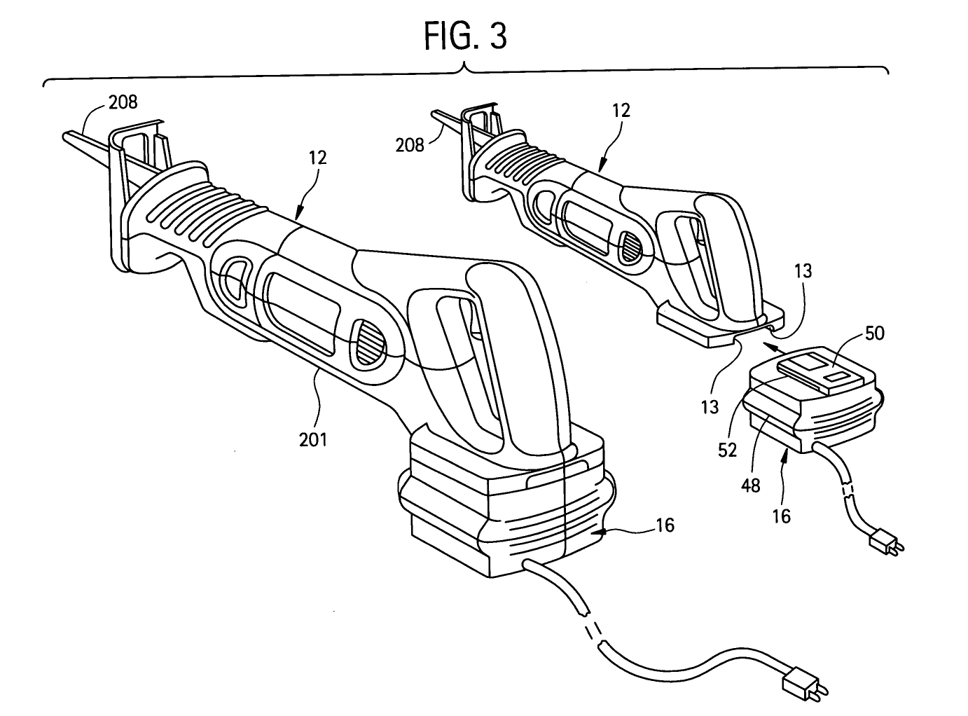

FIG. 2 is a three-dimensional view partially showing the manner of connecting a battery pack to a portable, electrically-operated device in accordance with an exemplary embodiment of the present invention, and FIG. 3 is a three-dimensional view partially showing the manner of connecting an AC/DC power converter module to the device of FIG. 2. While the exemplary embodiments of the present invention are shown and described with respect to a cordless power tool, and in particular to a reciprocating saw 12, it will be appreciated that the particular device is merely exemplary and could be another electrically-operated device such as a circular saw, drill, or any other similar portable power tool constructed in accordance with the teachings of the present invention.

Referring to FIGS. 2 and 3, a dual-mode, portable electrically-operated device according to the exemplary embodiments of the present invention is shown. The term ‘dual-mode’ means that the power tool is adapted so as to be powered with a cordless battery pack and also with an external power source via a corded AC/DC converter module that attaches to the power tool. The power tool 12 includes a DC motor (not shown) that may be adapted in the exemplary embodiments to be powered by a source that may be configured to provide any desired DC voltage, or a DC voltage within a given range. An exemplary given range of desired DC voltages may be a range from about 3.8 V to about 75 V.

In a first operating mode as shown in FIG. 2, the power tool 12 may be powered by a removable battery power supply module 14. The removable battery power supply module 14 may include a battery therein, which may be a multi-cell configuration of a Li+ battery, NiCd battery or NiMH battery, for example, although battery power supply module 14 is not limited to these battery chemistries and could also be configured to include one or more cells having another lithium-based or lead-acid battery chemistry, for example.

Alternatively, as shown in FIG. 3, the power tool 12 may be powered from a power source having a relatively high voltage such as common 115 or 120-volt AC line power via an AC/DC power converter module 16, hereafter ‘converter module 16’ for brevity. The converter module 16 is adapted so as to be plugged into the power tool 12, in place of the battery power supply module 14. Additionally, the power tool 12 may be powered from a relatively high voltage (about 40 volts or greater) DC generator (not shown) via the converter module 16.

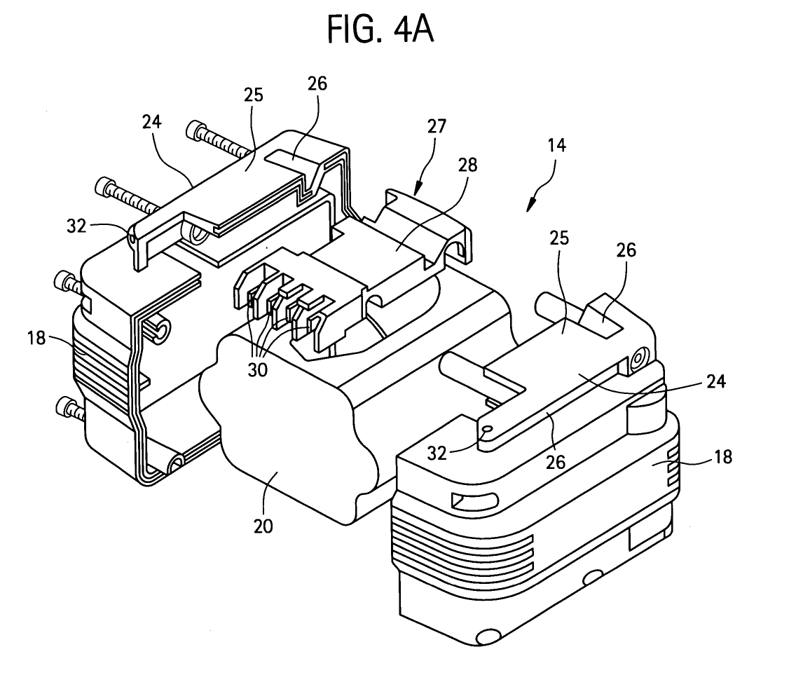

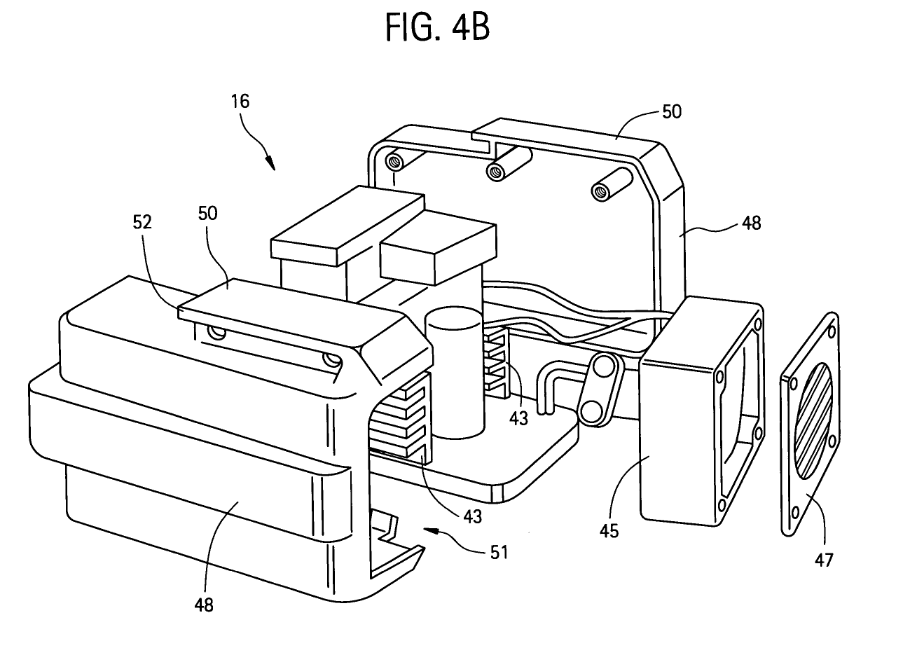

FIG. 4A is a three-dimensional exploded view of an exemplary battery pack. The rechargeable battery power supply module 14 may include a housing 18, a battery 20 (which may be composed of a number of battery cells), and a battery pack terminal block 27. To facilitate releasable attachment of the battery power supply module 14 to the tool 12, the upper portion 25 of the housing 18 may be formed to include a pair of guide rails 24. The guide rails 24 may be adapted to be slidably received into cooperating channels 13 (FIG. 2) formed in the housing of the tool 12. The upper portion 25 of the housing 18 may be further defined by a recess 26 to further facilitate removable attachment of the battery power supply module 14 to the tool 12. The recess 26 may be adapted to receive a latch (not shown) carried by the housing of the tool 12. The latch may be spring biased to a downward position so as to engage the recess 26 upon insertion of the rechargeable battery power supply module 14, for example. Removal of the battery power supply module 14 may thus be prevented until the spring bias of the latch is overcome in a conventional manner, insofar as the exemplary embodiments of the present invention are concerned.

The battery pack terminal block 27 may be composed of a main body portion 28 constructed of rigid plastic or another light-weight material and a plurality of blade-type terminals 30 (i.e., male terminals). In the illustrated exemplary embodiment, the battery pack terminal block 27 includes four blade terminals 30, this being only one possibility, fewer or additional terminals could be included. Two of the blade terminals 30 represent respective positive and negative terminals for the battery 20. A third terminal 30 may be used to monitor the temperature of the battery 20 and a fourth terminal may be used to identify the battery type (e.g., 24 volt NiCd). The male blade-type terminals 30 are merely exemplary, the battery pack terminal block 27 could alternatively be configured with female terminals.

FIG. 4B is a three-dimensional exploded view of the AC/DC power converter in accordance with an exemplary embodiment of the present invention. Referring to FIG. 4B, the converter module 16 is adapted to convert an unregulated AC source voltage from an external AC power source in a range of about 80 to about 440 volts to a desired DC voltage. In an exemplary embodiment, this could be a conversion from 115 volts AC to a desired volts DC. The housing 48 of the converter module 16 may be configured to be substantially similar to the housing 18 of the battery power supply module 14. In this regard, the housing 48 may include first and second clam shell halves joined at a longitudinally extending parting line. An upper portion 50 of the housing 48 may include a pair of guide rails 52 similar to those of the battery power supply module 14 for engaging the channels 13 in the tool housing. The upper portion 50 also defines a recess (not shown) which includes a latch (not shown) for preventing the inadvertent removal of the converter module 16.

The housing 48 may also include a recess 51 in which a fan 45 is adapted for providing cooling airflow to the converter module 16. A fan cover 47 may be attached to the fan 45 for preventing foreign objects from impeding the operation of the fan 45. The interior of housing 48 may include several heat sinks 43 to provide heat spreading and cooling for selected power converter components, for example.

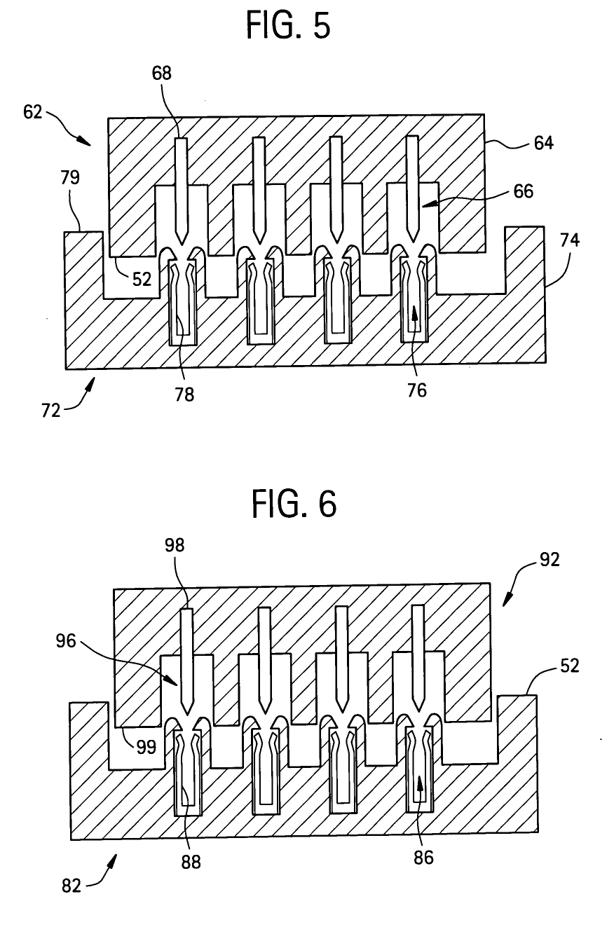

FIG. 5 is a two-dimensional view of an interface between the AC/DC power converter module and an exemplary terminal block of an electrically-operated device, in accordance with an exemplary embodiment of the present invention. An interface may be shown between a suitable terminal block 62 of the converter module 16 and a terminal block 72 of a portable, electrically-operated device such as power tool 12. As show in FIG. 5, terminal block 62 may be composed of a main body portion 64 constructed of rigid plastic or another light-weight material and a plurality of recesses 66 that each contain a male terminal or connector 68. Only four male terminals 68 are shown for simplicity, it being understood that greater or fewer male terminals could be provided based on a desired design of the terminal block 62. The terminal block 62 may form a portion of the housing 48 of the converter module 16 and includes guide rails 52 on upper portion 50, as shown in FIG. 4B, for example.

The terminal block 72 of the power tool 12 may be composed of a main body portion 74 constructed of rigid plastic or another light-weight material and a plurality of recesses 76 that each contain a corresponding pair of female terminals 78.

Female terminals 78 on the terminal block 72 may be adapted to receive the male terminals 68 of the converter module terminal block 62. The guide rails 52 may be adapted to engage laterally spaced rails 79 on the terminal block 72 as the converter module 16 is installed on the tool 12 to ensure desired and/or proper alignment between the female terminals 78 of tool 12 and the male terminals 68 of the converter module 16. Including male terminals 68 on the converter module 16 may provide a converter module 16 that is less susceptible to on-site damage (i.e., if dropped in mud or water, no sediment or water will enter to possibly short the converter, due to the male terminals). In addition to reducing the likelihood of failure due to water or debris, the isolated converter module 16 provides a terminal structure that may be consistent with that used for the battery pack terminal block 27.

FIG. 6 is a two-dimensional view of an interface between the AC/DC power converter module and an exemplary terminal block of an electrically-operated device, in accordance with an exemplary embodiment of the present invention. The converter module 16 could also be configured with female terminals. Referring to FIG. 6, the interface between a terminal block 82 of the converter module 16 and a tool terminal block 92 of a power tool 12 is shown. Within each of a plurality of recess 86, the converter module 16 includes a pair of female terminals 88 that are adapted to receive the male terminals 98 of the tool terminal block 92. The female terminals 88 may be recessed within the terminal block 82 of the converter module 16, for example.

In a manner somewhat similar to that described above in connection with the installation of the battery power supply module 14 on the tool 12, guide rails 52 may be adapted to engage laterally spaced rails 99 on the tool terminal block 92 as the converter module 16 is installed on the tool 12 to ensure proper alignment between the female terminals 88 of the converter module 16 and the male terminals 98 of the tool 12.

The exemplary embodiments of the present invention envision a converter module 16 that includes an AC/DC power converter that has a fixed-frequency, isolated, buck-derived topology. However, the principles of the exemplary embodiments of the present invention can be extended to variable-frequency converters and topologies other than a buck-derived topology, such as Cük and flyback converters. The AC/DC power converter circuitry within converter module 16 may be designed to convert an unregulated AC voltage to a regulated DC voltage that is usable by the power tool 12. For example, the converter module 16 can convert an input of 120 volts, 60 Hz AC to a desired DC voltage that is required by the power tool 12, such as a voltage in the range of about 3.8-75 volts DC, it being understood that the desired DC output voltage may be a function of the input AC voltage, component tolerances and/or the power requirements of the power tool 12.

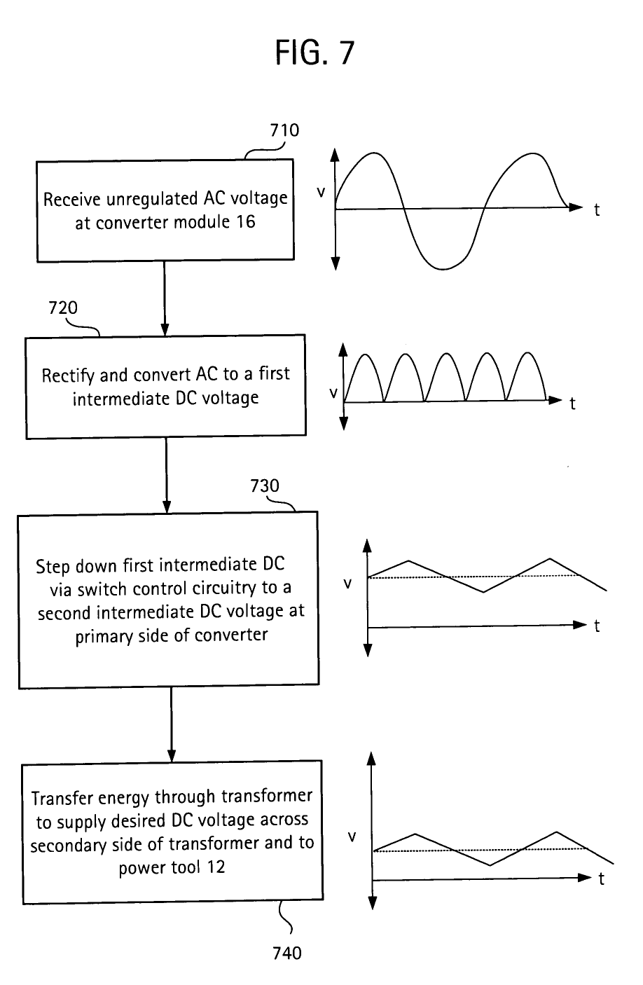

FIG. 7 is a flow diagram illustrating a method of isolating an electrically-operated device from a power source in the AC/DC power converter module of FIG. 3, in accordance with an exemplary embodiment of the present invention. Each function in FIG. 7 is provided with a voltage versus time representation to illustrate what is happening as an unregulated source voltage is converted to a desired DC voltage in the converter module 16 for powering a portable, electrically-operated device such as a power tool 12, for example.

Referring to FIG. 7, an unregulated AC voltage is received (710) from an external AC source via cord and plug (FIG. 2) to the converter module 16. The converter module 16 includes circuitry for an AC/DC voltage conversion process to rectify, convert and step down the unregulated AC voltage to a desired DC output voltage. The AC voltage is rectified and converted to a first intermediate DC voltage value (720), then is subjected to a step down operation (730). The step down function steps down the first intermediate DC voltage via switch mode circuitry and a primary side of a switch mode transformer (which occasionally may be referred to as an isolation transformer) acting as an output inductor to generate a second intermediate DC voltage. Energy is transferred (740) through the switch mode transformer to supply the desired DC voltage across the secondary side of the switch mode transformer and to the tool 12. Function 730 may be implemented in converter module 16 by switch mode control circuitry including the primary side coils of the switch mode transformer, which controls the desired DC voltage that is generated across the secondary side coils of the switch mode transformer.

As will be seen further below, electrical isolation between the external AC source and a power tool 12 may be provided in the converter module 16 due to the switch mode transformer. The switch mode transformer transforms the second intermediate DC voltage applied to the coils of the primary side to a desired DC voltage across secondary coils of the switch mode transformer. For example, an induced current across the primary coils of the primary side due to the second intermediate DC voltage generates a magnetic field. The magnetic field is translated to the secondary coils to induce a current and voltage across the secondary side coils that is proportional to the current and voltage across the primary side coils. Thus, the primary side of the transformer is electrically isolated from the secondary side of the transformer, and hence to the power tool 12, since a gap and/or associated insulation materials is configured between the primary and secondary sides of the switch mode transformer.

This use of switch mode control to control the secondary side of the switch mode transformer so as to provide electrical isolation in the converter module 16 may be an efficient way of converting AC to DC while maintaining isolation with smaller, lighter components. The transformer envisioned may be much smaller and substantially lighter than the conventional bulky power transformers. Since the secondary side of the transformer follows the primary side, a desired output DC voltage may be provided to tool 12.

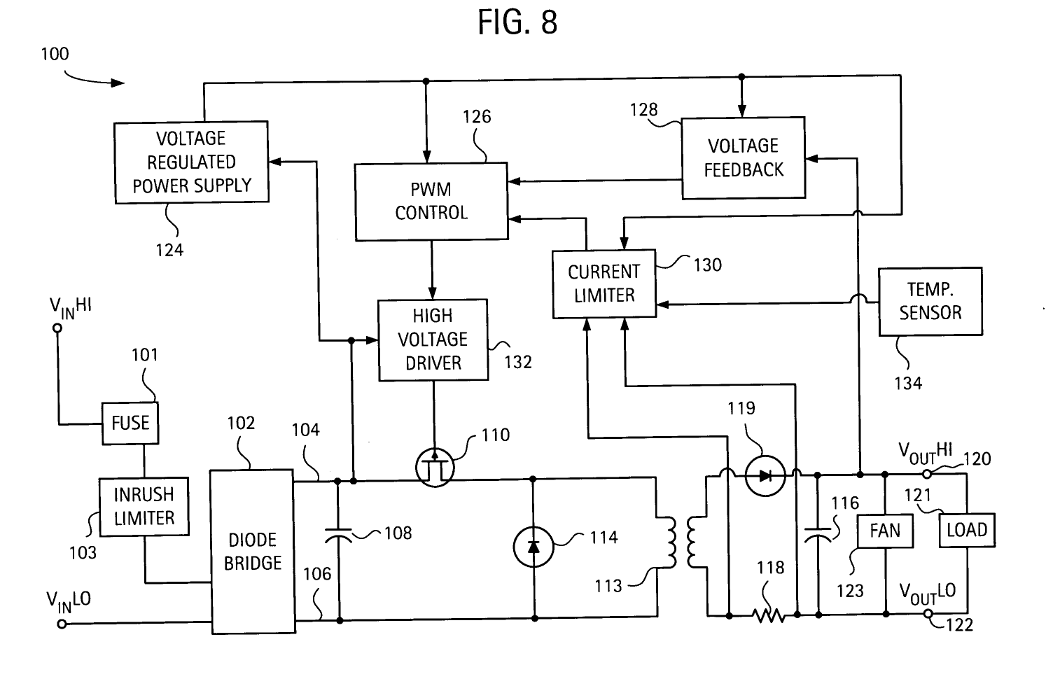

FIG. 8 is a block diagram of a power converter assembled and contained within the AC/DC power converter module 16. The power converter module 16 may include a fuse 101 in series with diode bridge 102 that receive an unregulated source voltage from an external power source. A power plug and cord (see FIG. 3) may connect from fuse 101 to the other input of diode bridge 102. The output of diode bridge 102 is applied between a high side line 104 and an inrush limiter 103 connected to ground reference line 106.

The rectified output voltage of diode bridge 102 is filtered by an input capacitor 108. The resulting filtered voltage may nominally be 165 volts DC, this being merely an exemplary filtered voltage. Accordingly, the unregulated source voltage may be rectified and converted to an intermediate DC voltage via diode bridge 102 and input capacitor 108.

The input capacitor 108 connects to the drains of parallel power transistors such as metal-oxide semiconductor, field-effect transistors (MOSFETs) 110a and 110b (shown generally as 110 in FIG. 8) that act as a voltage controlled switch. When MOSFETs 110a and 110b are in an ON state, the impedance between the drain and source is low. When MOSFETs 110a and 110b are in an OFF state, the impedance between drain and source is substantially high, effectively preventing current flow. The sources of MOSFETs 110a and 110b connect to the junction of a primary side of a switch mode transformer, hereafter ‘transformer 113’ and the cathode of free-wheeling output diode 114. Thus, the primary side of transformer 113 is controlled based on the cycling of MOSFETs 110a and 110b, which in turn is controlled by PWM control 126, via high voltage driver 132. The secondary side of transformer 113 is connected to an output capacitor 116 via a diode 119. Diode 119 is in series with the secondary winding on the transformer 113. The diode 119 prevents output capacitor 116 from discharging back through the secondary winding when MOSFETs 110a, 110b are off.

Accordingly, the intermediate DC voltage may be stepped down to a desired DC voltage at transformer 113. The transformer 113 may be controlled (e.g., at the secondary side) by switch control circuitry in the converter module 16. Exemplary switch control circuitry may generally comprise at least the PWM control 126, high voltage driver 132, MOSFETs 110a, 110b and the primary side coils of the transformer 113.

The transformer 113 may be embodied as a torodial gate drive transformer such as the lightweight and small (width 1.1 inches, height 1.350 inches, depth 0.760 inches) GDT 025100 manufactured by DT Magnetics International, Inc, for example, although this is only an exemplary transformer configuration. The transformer 113, by virtue of its construction of a primary coil on the primary side and a secondary coil on the secondary side, provides the voltage step down to the desired DC voltage, and/or to a voltage within a given voltage range that is suitable for the power tool 12, for example. Moreover, transformer 113 provides the desired electrical isolation (due to a gap between the coils and/or associated insulation material of the transformer 113) between converter module 16 (and hence the external power source) and the power tool 12, so as to substantially eliminate the possibility of components in the armature of the power tool 12 from becoming electrically active possibly shock an operator of the power tool 12.

A current sense resistor 118 may be connected between the secondary side of the transformer 113 and the output capacitor 116. The voltage across output capacitor 116 is applied to the output of converter module 16 across outputs V_{OUT}HI 120 and V_{OUT}LO 122, which connect to the male terminals 68 in FIG. 5 or pair of female terminals 88 in FIG. 6. A fan 123 may be connected in parallel with output capacitor 116. Diode bridge 102, MOSFET 110, free-wheeling output diode 114 and diode 119 may be mounted on heat sinks that provide heat spreading and a thermal path for dissipated power. Although current sense resistor 118 is shown connected between secondary side of the transformer 113 and the output capacitor 116, the current sense resistor 118 could be arranged at different locations in the block diagram of FIG. 8, such as in the V_{OUT}HI line between secondary side of the transformer 113 and the output capacitor 116, for example.

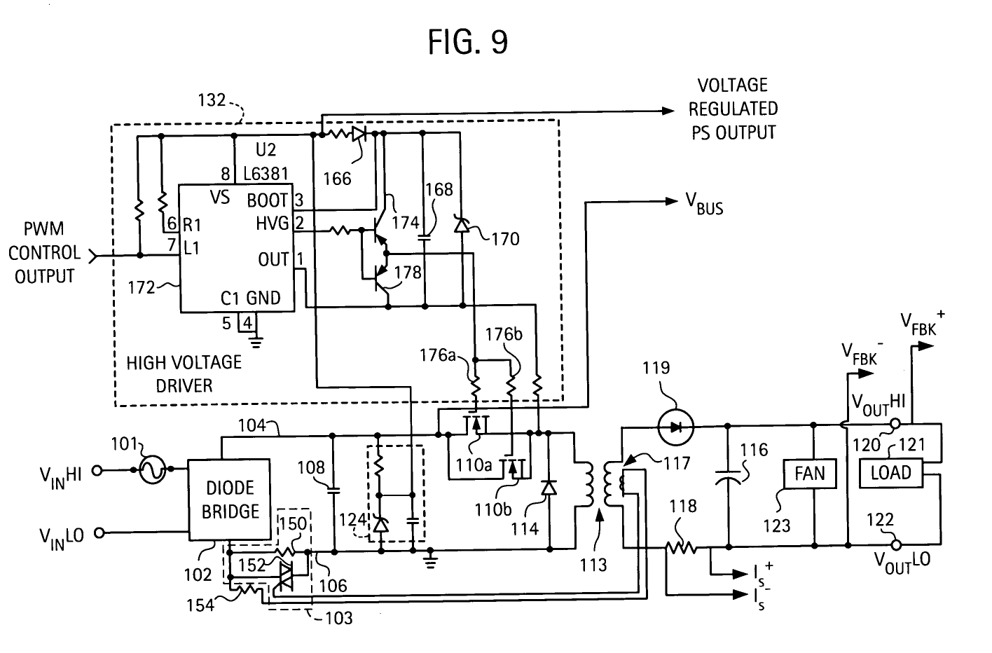

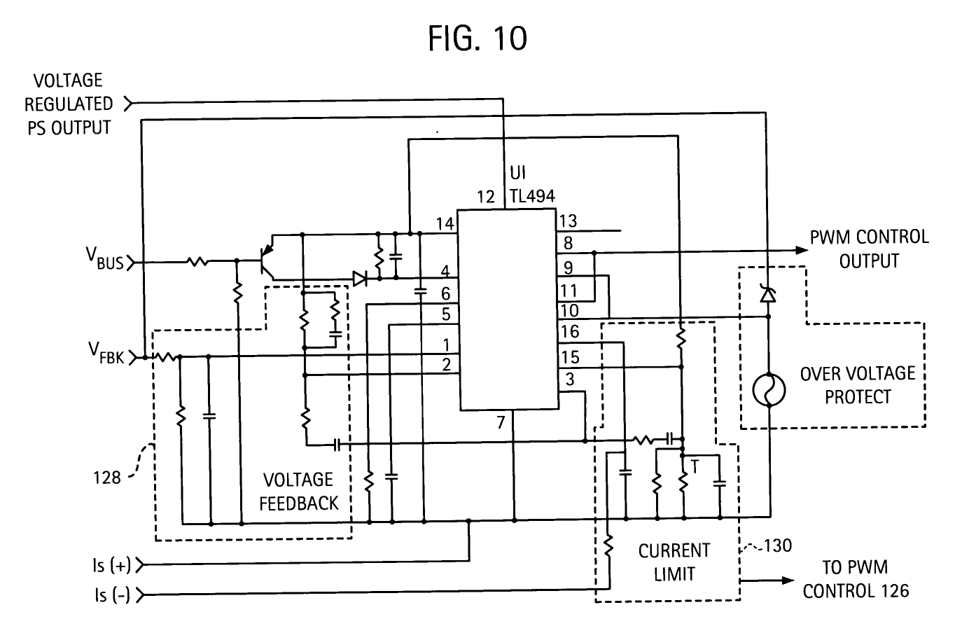

FIG. 9 is a schematic diagram of the power stage of the power converter of FIG. 8, and FIG. 10 is a schematic diagram of the control circuit of the power converter of FIG. 8. FIGS. 9 and 10 illustrate the circuitry that provides control and protection functions for converter module 16.

Referring to FIGS. 9 and 10, the converter module 16 may include a voltage regulated power supply 124. The voltage regulated power supply 124 connects across input capacitor 108 to provide a low power, regulated low voltage output to supply power to the internal circuitry of converter module 16. The regulated low voltage output (as well as the remainder of the internal circuitry) may be referenced to ground reference line 106. V_{OUT}HI 120 connects to voltage feedback 128 which connects to PWM control 126.

The converter module 16 may include a current limiter circuit 130. The current sense resistor 118 connects to current limiter 130 which also is connected to temperature sensor 134. The output of the current limiter 130 is an input to PWM control 126. The arrangement of components that comprise voltage regulated power supply 124, PWM control 126, voltage feedback 128, current limiter 130, and temperature sensor 134 are well known in the art.

FIGS. 9 and 10 also illustrate the circuitry that provides the power conversion function for converter module 16, which includes high voltage driver 132 and power stage components. The output of PWM control 126 drives the high voltage driver 132 which level shifts the output of PWM control 126 to drive the gates of MOSFETs 110a and 110b. The components that comprise high voltage driver 132 are well known in the art and are not explained in detail herein. In the exemplary embodiments of the present invention, an SGS-Thomson L6381 high-side driver 172 with associated components may comprise the high voltage driver 132. However, other circuit configurations for level-shifting the PWM output are within the scope of the exemplary embodiments of the present invention, such as discrete component configurations and Motorola high-side driver chips, for example.

Referring to FIG. 9, at initial power-on of power converter module 16, the power plug and cord are connected to an AC power source. The AC voltage is rectified by diode bridge 102 and applied across input capacitor 108. Current from the AC source surges as it flows through fuse 101, inrush limiter 103, diode bridge 102, and begins to charge input capacitor 108. The magnitude of the surge in current is limited to a safe level by the action of the inrush limiter 103, which is at a high impedance initially, but rapidly changes to a low impedance. In the exemplary embodiments, the inrush limiter 103 may be embodied as a triac 152 in parallel with a resistor 150 that is triggered by current flowing through the secondary side of transformer 113. In general, significant current flowing through the secondary side of transformer 113 flows through a tertiary sense winding and fires the triac 152 to close triac 152 (triggers triac 1520N) and will bypass resistor 154. However, other well known circuits may also be applicable, such as a series thermistor and/or high-valued series resistor in parallel with a controlled semiconductor that is triggered by temperature, time or current magnitude, for example.

As the voltage across input capacitor 108 rises towards its nominal value (here for simplicity assumed to be an exemplary intermediate voltage of about 165 volts DC) the voltage regulated power supply 124 becomes active and begins to supply voltage to the internal circuitry of the power converter module 16, including PWM control 126. During the initial charging of input capacitor 108, the triac 152 remains off, forcing return current to flow through resistor 150, thereby limiting the peak value of the inrushing current. The triac 152 remains OFF until the output of PWM control 126 becomes active, driving the MOSFETs 110a and 110b to the ON state, at which time current flowing through the secondary coils of transformer 113 couples through the tertiary sense winding 117 of transformer 113 to trigger triac 1520N.

The PWM control 126 in the present embodiment may be a Texas Instruments TL494 with associated components, as depicted in FIG. 10, for example. There are numerous other control chips which could be used, such as UC1845 and SG1625. The output of PWM control 126 is disabled until the regulated output of voltage regulated power supply 124 exceeds 6.4 volts, at which time a soft-start mode may be enabled.

The oscillator of PWM control 126 begins to operate prior to the beginning of soft-start. The exemplary embodiment switches at a fixed frequency of 40 kHz, although higher or lower frequencies are within the scope of the present invention. During steady-state operation of converter module 16, the PWM control 126 outputs a low-voltage square-wave signal having a variable pulse-width. The pulse-width may be adjusted to maintain a regulated output voltage at outputs V_{OUT}HI 120 and V_{OUT}LO 122. During soft-start, the pulse-width of the PWM control 126 output is initially zero, and gradually increases to a steady-state value that results in the output voltage being regulated at a desired voltage. The duration of soft-start mode may be controlled by the selection of component values in PWM control 126. For example, input pins of PWM control 126 could be given different signals that may be set with resistors.

The purpose of soft-start is to limit the current and voltage stress of the converter module 16 components during a time period when output capacitor 116 is being charged up to its nominal steady-state value. As the voltage across output capacitor 116 approaches its steady-state value, the output of the voltage feedback circuit 128 rises towards a steady-state value, resulting in the pulse-width of PWM control 126 attaining a steady-value that regulates the voltage across output capacitor 116 at the desired value.

Referring to FIG. 10, the feedback network for the voltage feedback circuit 128 is a lag-lead-lag-lead configuration with well known design requirements that is designed to maintain stable operation of the power converter module 16. During steady-state operation, the output from voltage feedback circuit 128 is sent to PWM control 126, which is then level-shifted by the high voltage driver 132 to repetitively drive the MOSFETs 110a and 110b into an ON state and an OFF state at the switching frequency.

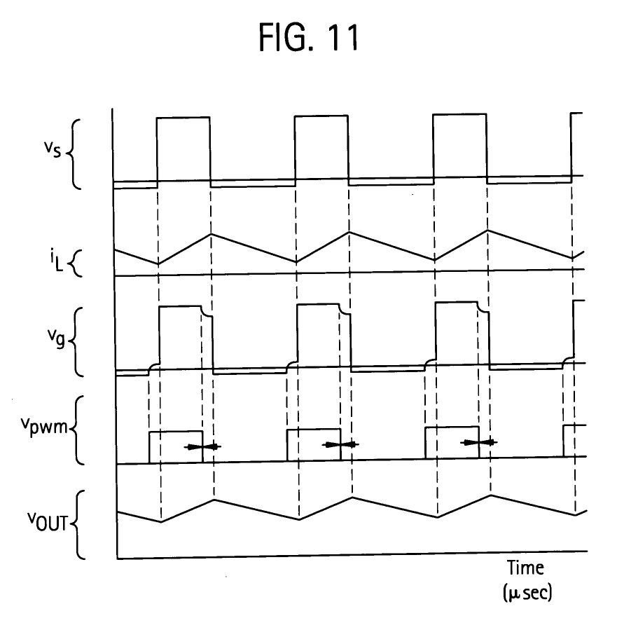

FIG. 11 is a signal diagram showing the voltage and current waveforms associated with the AC/DC power converter in accordance with an exemplary embodiment of the present invention. Referring to waveforms v_{S}, i_{L}, and v_{OUT} Of FIG. 11, and occasionally referring back to FIG. 8, when MOSFETs 110a and 110b are in the ON state, the voltage from input capacitor 108 is passed through to the sources of MOSFET 110a and 110b, vs, and impressed on the primary side coils of transformer 113, reverse biasing free-wheeling output diode 114. The voltage across the primary side coils of transformer 113 during the ON state is equal to the voltage across input capacitor 108. The positive voltage across the primary side coils of transformer 113 causes current (i_{L}) there through to increase at a linear rate. The current i_{L} is coupled through transformer 113 to the coils of the secondary side, inducing a proportional voltage and current across the secondary side of the transformer 113. The current from the secondary side splits between V_{OUT}HI 120 and output capacitor 116, with the DC component flowing to V_{OUT}HI 120 and the AC component substantially flowing through output capacitor 116. Current returning from load 121 flows from V_{OUT}LO 122 through current sensor resistor 118 and input capacitor 108, thereby completing the current path.

When the MOSFETs 110a and 110b are switched to the OFF state, the MOSFETs 110a, 110b present a high impedance to the voltage from input capacitor 108, decoupling that voltage from the remainder of the circuit. During this period free-wheeling output diode 114 is active. The current, i_{L}, from transformer 113, which previously flowed through MOSFETs 110a and 110b, now flows through free-wheeling output diode 114. Additionally, diode 119 prevents output capacitor 116 from discharging back through the secondary winding when MOSFETs 110a, 110b are switched off.

With output diode 114 conducting, the voltage, v_{S}, at the primary side of transformer 113 is approximately one diode voltage drop (e.g., voltage drop between about 0.4-1.0 volts) below ground reference line 106. The negative voltage across transformer 113 causes current i_{L} through the primary side coils of the transformer 113 to decrease at a linear rate. The current i_{L} is coupled through transformer 113 to the coils of the secondary side, inducing a proportional voltage and current across the secondary side coils of the transformer 113. The current from the secondary side again splits between V_{OUT}HI 120 and output capacitor 116, with the DC component flowing through V_{OUT}HI 120 and the AC component substantially flowing through output capacitor 116. The current returning from load 121 flows from V_{OUT}LO 122 through current sense resistor 118, is blocked from flowing through the secondary side coils of transformer 113 due to diode 119, and thus flows through free-wheeling output diode 114, thereby completing the current path. The MOSFETs 110a and 110b remain in the OFF state for the remainder of the cycle time period.

Again referring to FIG. 9, and with additional reference to waveforms v_{g} and V_{pwm} of FIG. 11, the output of PWM control 126 is level-shifted by high voltage driver 132 in order to drive power MOSFETs 110a and 110b to either the ON state or the OFF state. During the transition from the OFF state to the ON state, the PWM control 126 output voltage, V_{pwm}, transitions low which causes the output of driver 172 to transition high, thus biasing the base emitter junction of PNP transistor 178 turning it OFF. At the same time, NPN transistor 174 turns ON. Current flows through NPN transistor 174 and resistors 176a and 176b into the gates of power MOSFETs 110a and 110b, charging up the internal gate-source capacitance, raising the MOSFETs 110a and 110b gate voltage, v_{g}, above ground before returning from the sources of MOSFETs 110a and 110b to filter capacitor 168. The increasing voltage across the gate-source of MOSFETs 110a and 110b causes the MOSFETs 110a and 110b to begin to turn ON, causing the source voltage of MOSFETs 110a and 110b to increase from minus one volt (−1.0V) relative to ground reference line 106 to a value approaching the value of voltage across input capacitor 108 and additionally causing the MOSFETs 110a and 110b gate voltage, v_{g}, to increase to the value of voltage across input capacitor 108 plus the MOSFETs gate-source voltage.

As the source voltage of MOSFETs 110a and 110b increases, the decoupling diode 166 becomes reverse biased, decoupling the diode 166 from the remainder of the high voltage driver 132. Filter capacitor 168 remains referenced to the source of MOSFETs 110a and 110b and thereby provides the energy required to maintain the gate-source voltage of MOSFETs 110a and 110b during the remainder of the ON state.

The PWM control 126 output voltage, v_{pwm}, transitions from a low to high value to initiate the start of the OFF state. The high-side driver 172 inverts and level shifts the signal which causes NPN transistor 174 to turn OFF and PNP transistor 178 to turn ON. The energy stored in the internal gate-source capacitance of MOSFETs 110a and 110b discharges through resistor 176 and PNP transistor 178. When the gate-source voltage of MOSFETs 110a and 110b decreases to less than approximately four volts (4.0V), MOSFETs 110a and 110b turn OFF. Free-wheeling output diode 114 becomes active, which causes the voltage at the sources of MOSFETs 110a and 110b to decrease to −1.0V. Current then flows through decoupling diode 166 into filter capacitor 168, recharging the capacitor 168. Parallel zener diode 170 clamps the voltage across filter capacitor 168 to a value that does not overstress the gate-source junctions of the MOSFETs 110a and 110b. The circuit remains in the OFF state until the output of PWM control 126 once again transitions low.

In addition to controlling pulse width to maintain a constant output voltage, PWM control 126 also varies the pulse width in response to an output from current limiter 130 to protect converter module 16 from excessive output current loads. Output current flows through current sense resistor 118, causing a voltage to develop that is proportional to the output current. The voltage across current resistor 118 is compared to a reference voltage derived from the PWM control 126 reference. When the output current is greater than a given maximum level, the output of current limit 130 causes PWM control 126 to reduce the pulse width of the output. The reduced duty cycle causes the voltage at outputs V_{OUT}HI 120 and V_{OUT}LO 122 to decrease until the resulting output current is less than the given maximum level.

A temperature sensor 134 protects converter module 16 from over temperature stress of MOSFETs 110a, 110b and output diode 114. In the exemplary embodiment, a thermistor may be employed as temperature sensor 134 to monitor the temperature of heat sinks 43. If the temperature rises due to overload, debris blocking an air intake and/or other fault condition, temperature sensor 134 modifies the current limit reference voltage, thereby causing the PWM control 126 to generate a shorter pulse width. The shorter pulse width results in a lower output voltage and output current that corresponds to a lower overall output power. The lower output power causes a reduction in the power dissipated in the components of converter module 16, resulting in lower component temperatures.

FIG. 12 is a cross-sectional view of an armature of a non-insulated DC power tool motor usable with an isolated AC/DC power converter module in accordance with an exemplary embodiment of the present invention. In FIG. 12, a non-insulated DC motor armature 200 is illustrated. The armature 200 consists of a shaft 202 with a core built up over it. The core is composed of many laminations 206 with notches along the outer periphery (not shown) to hold the armature windings 204.

A gear or chuck (not shown) is built onto the shaft at one end of the armature 200 to provide a means of transferring rotational energy to the working end 208 (see FIG. 2 of the power tool 12). For example, a gear mechanism would convert rotational energy to the forward and back motion used to drive a reciprocating saw. The path from the armature shaft 202 to the gear mechanism or chuck, and finally to the working end is electrically conductive. Therefore, any electrical energy that exists on the armature shaft 202 is conducted to the working end 208, which is exposed to the operator of the power tool 12.

Working end 208 and locations 210 and 212 indicate areas of the rotor that could potentially become energized through contact with electrically live assemblies, if some type of electrical insulation is not employed. At working end 208, the armature shaft 202 could be energized through contact with energized armature laminations 206. At location 210, the armature shaft 202 could be energized through contact with end turns of the armature windings 204. At location 212 the armature laminations 206 could be energized through contact to end turns of the armature windings 204.

However, since complete electrical isolation is provided by the converter module 16 via transformer 113, there is little likelihood of locations 208, 210 and/or 212 being energized. Moreover, since electrical isolation is provided in the converter module 16, additional insulation layers such as the aforementioned double insulation may be omitted, potentially leading to cost savings in tool manufacture.

The converter module 16 in accordance with the exemplary embodiments of the present invention initially converts a low frequency AC voltage input to a high level intermediate DC voltage, then to a high frequency voltage level that is thereafter filtered to the lower voltage supply level of power tool 12. The power tool 12 need not employ double insulation of the motor, due to the use of a low cost switch mode transformer 113 provided in the converter module 16. This may significantly reduce the cost and weight of the converter module 16, and may also lead to a reduction in manufacturing cost of the power tool 12.

In addition, the converter module 16 is designed with a comparatively small number of components while providing an efficient conversion process. This may further enhance the lightweight, compact features of the converter module 16. The size of the converter module 16 may further permit the use of the converter in electrically-operated power devices, such as the reciprocating saw 12, which heretofore were too small to support and contain conversion units providing power in a range of at least 50 watts and higher.

Further, while the exemplary embodiments described herein provide an AC/DC power converter module 16 that converts a low frequency, high voltage level to a low DC voltage level, the converter could also be useable to convert a high DC voltage level to a low voltage DC level by applying the high DC level directly to a suitable power cord and plug that connects to the input of AC/DC power converter module 16. In this manner, the power tool 12 could be operated from the high DC voltage source instead of the low DC voltage of the cells in battery power supply module 14, which thereby may conserve the charge life of the cells.

The converter module 16 could be designed to operate from external AC power sources other than 120 volts at 60 Hz. Without departing from the spirit and scope of the invention, the converter module 16 also could be designed to provide DC output voltage levels at any desired range of output voltage levels, and/or based on any desired application. An exemplary range may be a range of DC output voltage levels from about 3.6 volts to about 75 volts, although DC output voltage levels in excess of 75 V are foreseen in accordance with the exemplary embodiments.

In a particular example, the converter module 16 could be adjusted to develop a DC output of 48 volts between the outputs V_{OUT}HI 120 and V_{OUT}LO 122 derived from an external AC source of 220 volts at 50 Hz as applied to a suitable power plug and cord. The AC/DC power converter module 16 could then be used to provide an inexpensive dual mode capability (battery pack or corded AC power source) for power-operated devices that operate at a DC voltage supply level of at least about 10.8 volts DC and higher.

The reciprocating saw 12 is merely an illustrative example of various electrically-operated, cordless-mode power devices that may become more versatile because of the inventive cost efficient capabilities of the isolated AC/DC converter module 16. Other examples of power-operated cordless devices which may be enhanced by the inventive concepts herein include, but are not limited to, drills, screwdrivers, screwdriver-drills, hammer drills, jig saws, circular saws, hedge trimmers, grass shears and/or lawn mowers, as well as battery-operated household products, appliances and the like.

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

1. A method of electrically isolating an electrically-operated device from an external power source providing an AC source voltage that is converted to a desired DC voltage for powering the device within a corded converter module operatively attached to the device, the converter module including a switch-mode transformer therein, the method comprising:
using switch mode control in the converter module to control a secondary side of the switch-mode transformer, so as to electrically isolate the device from the external power source in the converter module.

2. The method of claim 1, wherein using further includes controlling a duty cycle at which a pair of transistors in the converter module cycle to provide electrical isolation between a primary side and the secondary side of the switch-mode transformer.

3. The method of claim 2, wherein said duty cycle is controlled based on pulse width modulation.

4. The method of claim 1, further comprising:
converting an unregulated source voltage form the external power source to an intermediate DC voltage, and
stepping down the intermediate DC voltage to the desired DC voltage in the isolation transformer based on said controlling.

5. The method of claim 4, wherein said source voltage is one of an unregulated AC voltage or DC voltage.

6. The method of claim 4, wherein
said source voltage is an unregulated AC voltage in a range of about 110-440 volts, and
said desired DC voltage is a DC voltage in a range of about 3.8-75 volts.

7. The method of claim 1, wherein the electrically-operated device is a power tool.

8. A method of powering an electrically-operated device adapted to be powered from both a removable cordless power supply and a removable corded power supply, the corded power supply including a converter module for converting a source voltage from the corded power supply to a desired DC voltage for powering the device, comprising:
removing the cordless power supply from the device;
attaching the converter module to the device the converter module including a cord connected to an unregulated source voltage for providing said source voltage to the converter module and including an isolation transformer therein;
converting the unregulated source voltage to an intermediate DC voltage in the converter module,
controlling a duty cycle at which a pair of transistors in the module cycle to control a primary side of the isolation transformer so as to provide electrical isolation between the primary and secondary sides of the isolation transformer to electrically isolate the corded power supply from the device,
stepping down the intermediate DC voltage to the desired DC voltage in the isolation transformer of the module; and
powering the device with the desired DC voltage.

9. The method of claim 8, wherein said duty cycle is controlled based on pulse width modulation.

10. The method of claim 8, wherein said source voltage is one of an unregulated AC voltage or DC voltage.

11. The method of claim 8, wherein
said source voltage is an unregulated AC voltage in a range of about 110-440 volts, and
said desired DC voltage is a DC voltage in a range of about 3.8-75 volts.

12. The method of claim 8, wherein the electrically-operated device is a power tool.

13. A method of supplying power to a power tool operable in a given voltage range, said power tool having exposed surfaces, the method comprising
connecting a corded, isolated power supply module to the power tool and to a AC source of relatively high voltage electric power, wherein the corded, isolated power supply module provides electrical isolation for the power tool by controlling a duty cycle at which a pair of transistors in the module cycle to prevent the exposed surfaces of the power tool from becoming electrically energized;
converting power from the AC source to a DC voltage isolated from the AC source, wherein said DC voltage is within the given voltage range; and
powering the power tool with the DC voltage.

14. A corded/cordless system for a power tool, comprising:
a power tool operable at a given DC voltage, said power tool having a motor, an exterior and an interior;
a power tool interface for mechanically and electrically mating with a power supply module; and
a corded, isolated power supply module having a cord connected to an external source of electric power, the module releasably attached to the DC power tool and including a circuit adapted to convert an AC source voltage from the external source to a desired DC voltage for powering the power tool, the circuit including an isolation transformer therein to electrically isolate the external source from the power tool by controlling a duty cycle at which a pair of transistors in the isolation transformer cycle to electrically isolate a primary side from a secondary side of the isolation transformer.

15. The system of claim 14, further comprising:
a cordless battery power supply module mechanically and electrically configured to mate with the power tool and including a battery assembly providing a DC voltage in a given voltage range for powering the power tool, wherein the power tool is configured to receive power from either the corded, isolated power supply module or the battery power supply module.

16. The system of claim 14, wherein the power tool interface includes a physical envelope configuration so as to accept either said corded, isolated power supply module or said cordless battery power supply module.

17. The system of claim 14, wherein the power tool interface includes an electrical connector operative to electrically connect to an electrical connector attached to either of said corded, isolated power supply module or said cordless battery power supply module.

18. The system of claim 17, wherein the corded, isolated power supply module electrical connector is a terminal block and the battery power supply module electrical connector is a terminal block.

19. The system of claim 14, wherein the power tool interface further includes a latch for releasably securing either of said corded, isolated power supply module and said cordless battery power supply module.

20. A converter module for converting electrical power from an external power source to a desired DC voltage for a portable, electrically-operated device and adapted to be releasably attached to the device, the converter module comprising:
converting means for converting a given unregulated source voltage to an intermediate DC voltage;
an isolation transformer for stepping down the intermediate DC voltage to a desired DC voltage and serving to electrically isolate the device from the external power source; and
control circuitry for controlling a duty cycle at which a pair of transistors of the isolation transformer cycle to control a primary side of the isolation transformer.

21. The converter module of claim 20, wherein the converter module represents an alternative power supply to a cordless battery power supply module that is adapted to be releasably attached to the device for providing a desired DC voltage.

22. The converter module of claim 20, wherein said duty cycle is controlled based on pulse width modulation.

23. The converter module of claim 20, wherein
said source voltage is an unregulated AC voltage in a range of about 110-440 volts, and
said desired DC voltage is a DC voltage in a range of about 3.8-75 volts.

24. The converter module of claim 20, further comprising one or more male terminals for engaging corresponding female terminals of the device.

25. The converter module of claim 20, further comprising one or more female terminals for engaging corresponding male terminals of the device.

26. The converter module of claim 20, wherein the portable, electrically-operated device is a power tool.

27. A non-isolated power tool adapted to receive one of a releasably attachable cordless battery supply module and a releasably attachable corded converter module, in which electrical isolation resides in the attached battery supply module or converter module.
